(19) United States
(12) Patent Application Publication
(10) Pub. No.: US 2024/0152678 A1
(43) Pub. Date: May 9, 2024

(54) ELEMENT SEARCH METHOD AND APPARATUS, COMPUTER DEVICE AND STORAGE MEDIUM

(71) Applicant: Glenfly Tech Co., Ltd., Shanghai (CN)

(72) Inventor: Yuan JIANG, Shanghai (CN)

(21) Appl. No.: 18/226,672

(22) Filed: Jul. 26, 2023

(30) Foreign Application Priority Data
Nov. 7, 2022 (CN) 202211385002.8

(51) Int. Cl. G06F 30/392

(52) U.S. Cl. CPC G06F 30/392; G06F 2115/12

(57) ABSTRACT

The present disclosure relates to an element search method and apparatus, a computer device, a storage medium and a computer program product. The method includes: acquiring an element search instruction carrying an element identifier information of a target element; determining an element prediction type matching the target element based on the element identifier information; searching for the target element on a search panel according to the element prediction type to acquire element attribute information of the target element; determining a target layer of the target element in a Printed Circuit Board (PCB) layout based on the element attribute information, opening the target element at the target layer, and highlighting the opened target element. Accordingly, the efficiency of searching for the element can be improved.

### CROSS REFERENCES TO RELATED APPLICATION

The present application claims priority to Chinese patent application No. 202211385002.8, titled “Element Search Method and Apparatus, Computer Device and Storage Medium”, and filed on Nov. 7, 2022, the content of which is hereby incorporated by reference in its entirety.

### TECHNICAL FIELD

The present disclosure relates to the field of computer technology, and particularly to an element search method and apparatus, a computer device, a storage medium and a computer program product.

### BACKGROUND

With the development of computer technology, the Printed Circuit Board (PCB) is widely used in electronic circuit systems as the carrier of chips and electronic devices, while the Electronic Design Automation (EDA) is more and more involved in all stages of the hardware system design and debugging as the design and debugging tool of the PCB.

During the common use of EDA tools, it is often necessary to search for different elements and then perform subsequent operations for the different elements. For example, during the design process, it is necessary to search for a certain device and then rotate the angle or wire the device. For example, during the debugging process, it is necessary to search for a certain segment of wire or a via hole, then to test and measure the signal or other operations.

At present, most of the conventional element search methods need the user to determine the category of the element to be searched for by himself, and then identify the element to be searched for from a large number of corresponding elements in the corresponding category. When a search error occurs, the user needs to re-determine the category, etc. The operation process is generally too complicated, which results in lower efficiency, so a lot of effort and time are wasted.

### SUMMARY

In view of this, as for the above technical problem, it is necessary to provide an element search method and apparatus, a computer device, a computer readable storage medium and a computer program product capable of improving the efficiency of searching for an element.

In the first aspect of the present disclosure, an element search method is provided, including:
acquiring an element search instruction carrying an element identifier information of a target element;
determining an element prediction type matching the target element based on the element identifier information;
searching for the target element on a search panel according to the element prediction type to acquire element attribute information of the target element;
determining a target layer of the target element in a Printed Circuit Board (PCB) layout based on the element attribute information, opening the target element at the target layer, and highlighting the opened target element.

In an embodiment, the element search instruction further carries trigger information; the method further includes:
before determining the element prediction type matching the target element based on the element identifier information,
determining whether the trigger information matches predefined trigger information;
determining whether the element identifier information meets a search requirement when the trigger information matches the predefined trigger information;
when the element identifier information meets the search requirement, performing the step of determining the element prediction type matching the target element based on the element identifier information.

In an embodiment, the determining the element prediction type matching the target element based on the element identifier information includes:
directly determining the element prediction type matching the target element according to the element identifier information when the element identifier information excludes a preset symbol;
disassembling the element identifier information when the element identifier information includes the preset symbol, and determining the element prediction type matching the target element according to a disassembly result.

In an embodiment, the searching for the target element on the search panel according to the element prediction type includes:
searching for a symbol element on the search panel according to the element identifier information when the element prediction type is a symbol type;
searching for a character layer number element on the search panel according to the element identifier information when the element prediction type is a character layer number type;
searching for a Nets connection element on the search panel according to the element identifier information when the element prediction type is a Nets connection type;
disassembling the element identifier information on the search panel to obtain a disassembly result when the element prediction type is a pin type, and searching for a pin element according to the disassembly result;
searching for at least one initial copper foil element on the search panel according to the element identifier information when the element prediction type is a copper foil type, and determining a target copper foil element according to an area of each initial copper foil element;
searching for a differential pair element on the search panel according to the element identifier information when the element prediction type is a differential pair type;
searching for a footprint element on the search panel according to the element identifier information when the element prediction type is a footprint type.

In an embodiment, the element attribute information comprises element mirroring information; the target layer comprises a top layer, a bottom layer or an inner layer; and the determining the target layer of the target element in the PCB layout based on the element attribute information includes:
when the element prediction type is the symbol type, determining that the symbol element is located at the top layer of the PCB layout when element mirroring information of the symbol element is a first mark, and determining that the symbol element is located at the bottom layer of the PCB layout when the element mirroring information of the symbol element is a second mark;
when the element prediction type is the character layer number type, determining that the character layer number element is located at the top layer of the PCB layout when element mirroring information of the character layer number element is the first mark, and determining that the character layer number element is located at the bottom layer of the PCB layout when the element mirroring information of the character layer number element is the second mark;
directly determining the target layer of the Nets connection element as one of the top layer, the bottom layer, or the inner layer when the element prediction type is the Nets connection type;
when the element prediction type is the pin type, determining that the pin element is located at the top layer of the PCB layout when element mirroring information of the pin element is the first mark, and determining that the pin element is located at the bottom layer of the PCB layout when the element mirroring information of the pin element is the second mark;
when the element prediction type is the copper foil type, determining that the target copper foil element is located at the top layer of the PCB layout when element mirroring information of the target copper foil element is the first mark, and determining that the target copper foil element is located at the bottom layer of the PCB layout when the element mirroring information of the target copper foil element is the second mark;
directly determining the target layer of the differential pair element as one of the top layer, the bottom layer, or the inner layer when the element prediction type is the differential pair type;
when the element prediction type is the footprint type, determining that the footprint element is located at the top layer of the PCB layout when element mirroring information of the footprint element is the first mark, and determining that the footprint element is located at the bottom layer of the PCB layout when the element mirroring information of the footprint element is the second mark.

In an embodiment, the element attribute information includes element position information; the opening the target element at the target layer and highlighting the opened target element includes:
opening the target element at the target layer based on the element position information;
scaling and highlighting the opened target element before highlighting the target element at the target layer.

In the second aspect of the present disclosure, an element search apparatus is provided, including:
an instruction acquisition module, configured to acquire an element search instruction carrying an element identifier information of a target element;
a matching module, configured to determine an element prediction type matching the target element based on the element identifier information;
an information acquisition module, configured to search for the target element on a search panel according to the element prediction type, to acquire element attribute information of the target element;
a processing module, configured to determine a target layer of the target element in a Printed Circuit Board (PCB) layout based on the element attribute information, open the target element at the target layer, and highlight the opened target element.

In the third aspect of the present disclosure, a computer device is provided, including a processor and a memory for storing a computer program, wherein the processor, when executing the computer program, implements the above-mentioned element search method.

In the fourth aspect of the present disclosure, a computer-readable storage medium is provided, on which a computer program is stored, the above-mentioned element search method is implemented when the computer program is executed by a processor.

In the fifth aspect of the present disclosure, a computer program product is provided, including a computer program, the above-mentioned method is implemented when the computer program is executed by a processor.

In the element search method and apparatus, the computer device, the storage medium and the computer program product, the element search instruction carrying an element identifier information of the target element is acquired, the element prediction type matching the target element is automatically determined based on the element identifier information; further, the target element is searched for on the search panel according to the element prediction type to acquire element attribute information of the target element; finally, the target layer of the target element in the Printed Circuit Board (PCB) layout is determined based on the element attribute information, the target element is opened at the target layer, and the opened target element is highlighted. Accordingly, the target element can be automatically highlighted in the PCB layout by only acquiring the element search instruction carrying the element identifier information of the target element, thereby addressing the technical problem that the manually searching for the target element according to the set search steps may take a long time, and greatly improving the efficiency of searching for the element.

### BRIEF DESCRIPTION OF THE DRAWINGS

FIG. 1 is a flow chart showing an element search method according to an embodiment of the present disclosure.

FIG. 2 is a flow chart showing an element search method according to another embodiment of the present disclosure.

FIG. 3 is a flow chart showing an element search method according to another embodiment of the present disclosure.

FIG. 4 is a flow chart showing an element search method according to another embodiment of the present disclosure.

FIG. 5 is a schematic application structure diagram of an element search method according to an embodiment of the present disclosure.

FIG. 6 is a schematic application structure diagram of an element search method according to another embodiment of the present disclosure.

FIG. 7 is a flow chart showing an element search method according to another embodiment of the present disclosure.

FIG. 8 is a schematic structure diagram of an element search apparatus according to an embodiment of the present disclosure.

FIG. 9 is an internal structure diagram of a computer device according to an embodiment of the present disclosure.

### DETAILED DESCRIPTION

In order to make the purpose, technical solution and advantages of the present disclosure clearer, the present disclosure will be further detailed with reference to the accompanying drawings and embodiments. It should be appreciated that the embodiments described herein are merely intended to explain the disclosure, rather than limiting the present disclosure.

The element search method provided by the embodiment of the present disclosure can be applied to a terminal on which an operable Electronic Design Automation (EDA) design and a debugging tool for a Printed Circuit Board (PCB) is provided. When the user uses the EDA to perform the PCB layout design, the user may need to search for a certain device, and then rotate the angle of or wire the device after the search. Alternatively, after the PCB layout design is completed, the designed PCB layout needs to be debugged; during the debugging process, the user may need to search for a certain segment of wiring or through hole, and then perform operations such as testing and measuring the signal; then the user can input an element search instruction through a signal input unit (such as a command input window on a front-end page) of the terminal; or the user can output the element search instruction to the terminal through any electronic device with a controller, such as a mobile phone, a tablet, etc. The terminal acquires the element search instruction carrying element identifier information of a target element. An element prediction type matching the target element is determined based on the element identifier information. The target element is searched for on a search panel according to the element prediction type, to acquire element attribute information of the target element. A target layer of the target element in the PCB layout is determined based on the element attribute information; and the target element is opened at the target layer, and the opened target element is highlighted, which can improve the search efficiency of the element. The terminal can be, but not limited to various personal computers, laptops, smartphones, tablet computers, Internet of Things devices and portable wearable devices. The Internet of Things devices can be smartwatches, smart TVs, smart air conditioners, smart vehicle devices, etc. The portable wearable devices can be smartwatches, smart bracelets, headsets, and so on.

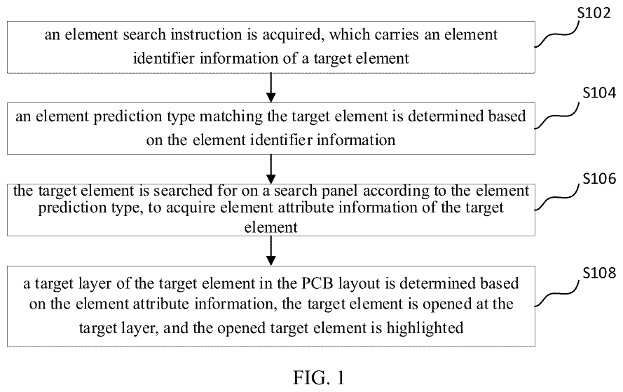

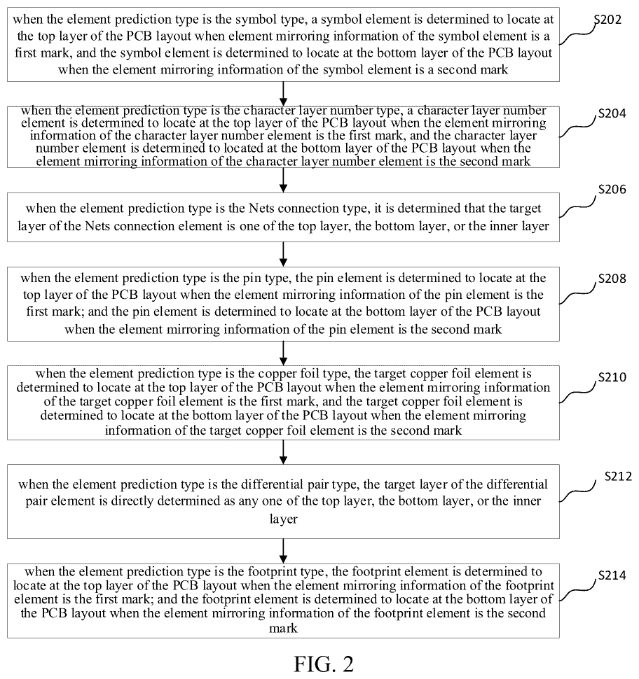

In an embodiment, as shown in FIG. 1, an element search method is provided, the method is applied to a terminal as an example, and includes the following steps.

Step S102: an element search instruction is acquired, which carries element identifier information of a target element.

The element search instruction is an instruction configured to search for a target element. Specifically, the element search instruction can be an instruction inputted by a user through a signal input unit of the terminal itself (such as a command input window on a front-end page), or can also be an instruction outputted to the terminal by the user through any electronic device with a controller, such as a mobile phone or a tablet. The target element can be an element needing to be searched for by the user in a current design or debugging process. The element identifier information refers to information configured to distinguish different elements. Each element has corresponding element identifier information. Specifically, the element identifier information can be any identifier such as numbers, letters, and character codes, as long as different elements can be distinguished.

In an embodiment, a name, a number, a sequence number and the like of the element can directly serve as the element identifier information. Specifically, the element identifier information may be EN_VDD50 (the name of a Nets connection), U1.3 (a pin name of a chip), etc.

Step S104: an element prediction type matching the target element is determined based on the element identifier information.

The element prediction type refers to a predicted type to which the target element may belong. Each element prediction type may only include one type of element or a plurality of types of elements. The terminal can determine the element prediction type matching the target element according to the element identifier information.

In an embodiment, the terminal can perform keyword matching with predefined element identifier information corresponding to each predefined element prediction type according to the element identifier information, and determine the element prediction type matching the target element according to a keyword matching result.

Step S106: the target element is searched for on a search panel according to the element prediction type, to acquire element attribute information of the target element.

The search panel may be a Find panel coming with the EDA software; and element attribute information can be information related to properties of each element. Specifically, the element attribute information can be key information of the element, such as a position coordinate, layer information (mirroring information), and a name of the element in the PCB layout. The element attribute information can be temporarily stored in a temporary database for future use. The terminal can search for the target element on the search panel, to acquire the element attribute information of the target element.

Step S108: a target layer of the target element in the PCB layout is determined based on the element attribute information, the target element is opened at the target layer, and the opened target element is highlighted.

The PCB layout can refer to an actual component arrangement and wiring diagram that has been made, or can refer to an actual component arrangement and wiring diagram that is being designed. Since PCB layout can generally include a plurality of layers, the target layer can refer to a specific layer of the PCB layout where the target element is actually located. Specifically, the target layer in the PCB layout may include a bottom layer, a surface layer, and an inner layer. The bottom layer may refer to a lower surface (also referred to as a Bottom layer) in the PCB layout; and a top layer corresponds to the bottom layer. Other layers located between the top and bottom layers can be collectively referred to as an inner layer.

The terminal can determine the target layer of the target element in the PCB layout according to the element attribute information, open the target element at the target layer, and finally highlight the opened target element. Therefore, the target element is opened at the target layer where the target element is located and the opened target element is highlighted, which can assist the design process and the debugging process of the user, etc., and improve the work efficiency of the user.

In the above element search method, the element search instruction carrying the element identifier information of the target element is acquired; the element prediction type matching the target element can be automatically determined based on element identifier information; furthermore, the target element is searched for on the search panel according to the element prediction type, to determine the element attribute information of the target element; finally, the target layer of the target element in the PCB layout is determined according to the element attribute information, the target element is opened at the target layer, and the opened target element is highlighted. In such a manner, only the element search instruction carrying the element identifier information of the target element needs to be obtained, the target element can be automatically highlighted in the PCB layout, which can solve the problem that the manually searching for the target element according to set search steps may take a long time, and greatly improve the efficiency of searching for the element.

In an embodiment, the element search instruction further carries trigger information. Before the step of determining the element prediction type matching the target element based on the element identifier information, the method further includes: it is determined that whether the trigger information matches predefined trigger information; when the trigger information matches the predefined trigger information, it is determined whether the element identifier information meets a search requirement; when the element identifier information meets the search requirement, the step of determining the element prediction type matching the target element based on the element identifier information is performed.

The trigger information can refer to trigger source information configured to trigger the terminal to perform subsequent steps. The subsequent steps may include a series of steps such as the step of determining the element prediction type matching the target element based on the element identifier information. The predefined trigger information refers to pre-defined trigger source information; and the terminal may only proceed with the subsequent steps when it is determined that the trigger information matches the pre-defined trigger source information.

The predefined trigger information can be any characters, letters, numbers, and character codes, etc. For example, the predefined trigger information in the embodiment consists of letters, such as “fx”. When the trigger information is “fx”, the terminal performs the step of determining the element prediction type matching the target element based on the element identifier information.

In the above embodiment, the terminal matches the trigger information with the predefined trigger information, and only controls the execution of subsequent steps when the trigger information matches the predefined trigger information. Accordingly, the search process can be standardized, and the element search processes caused by false triggering of the user can be avoided.

In an embodiment, the step of determining the element prediction type matching the target element based on the element identifier information includes:
when the element identifier information excludes a preset symbol, the element prediction type matching the target element is directly determined according to the element identifier information;
when the element identifier information includes a preset symbol, the element identifier information is disassembled, and the element prediction type matching the target element is determined according to a disassembly result.

The preset symbol refers to a symbol set to determine whether to disassemble the element identifier information. When determining that the element identifier information includes a preset symbol, the terminal may disassemble the element identifier information. Specifically, the preset symbol can be either a punctuation mark or any representative identifier, for example, the preset symbol can be a punctuation mark “.”, when determining that there is a “.” in the element identifier information, the terminal may disassemble the element identifier information and determine the element prediction type matching the target element based on the disassembly result; when determining that there is no “.” in the element identifier information, the terminal may directly determine the element prediction type matching the target element according to the element identifier information.

In an embodiment, the element identifier information is u2.2, and if the terminal determines that there is a “.” in u2.2, the terminal disassembles u2.2 to obtain u2 and 2. Then the terminal can determine that the element prediction type is a pin prediction type according to u2.

In the above embodiment, as for the element identifier information that excludes a preset symbol, the terminal can directly determine the element prediction type matching the target element. As for the element identifier information including a preset symbol, the terminal may disassemble the element identifier information to obtain the disassembly result, and determine the element prediction type according to the disassembly result. Accordingly, the accuracy and flexibility in the matching process of the element prediction type are improved.

In an embodiment, if the element prediction type is a symbol type, a symbol element is searched for on the search panel according to the element identifier information. If the element prediction type is a character layer number type, a character layer number element is searched for on the search panel according to the element identifier information. If the element prediction type is a Nets connection type, a Nets connection element is searched for on the search panel according to the element identifier information. If the element prediction type is a pin type, the element identifier information is disassembled on the search panel to obtain the disassembly result; and a pin element is searched for according to the disassembly result. If the element prediction type is a copper foil type, at least one initial copper foil element is searched for on the search panel according to the element identifier information; and a target copper foil element is determined according to an area of each initial copper foil element. If the element prediction type is a differential pair type, a differential pair element is searched for on the search panel according to the element identifier information. If the element prediction type is a footprint type, a footprint element is searched for on the search panel according to the element identifier information.

The element prediction type can include any of a symbol type, a character layer number type, a Nets connection type, a pin type, a copper foil type, a differential pair type, and a footprint type.

The symbol type refers to a SYMTYPE type; and the SYMTYPE type represents a symbol (symbols of all PCB boards, not necessarily with serial numbers) device. The symbol device may include all electrical devices and mechanical structures. When the element prediction type is the symbol type, the terminal can directly open the symbol device on the search panel according to the element identifier information to search for a symbol element. Specifically, the element identifier information of the symbol element may be FIXOPT, and the terminal may search for FIXOPT in the SYMTYPE type on the search panel.

The character layer number type refers to an REFDES type which may indicate an element number character layer number and is generally configured to debug a device having electrical characteristics and check the basic information of a device, etc. When the element prediction type is the character layer number type, the terminal can open Components (components with sequence numbers in the PCB) on the search panel, and search for a character layer number element according to the element identifier information. Specifically, the element identifier information of the character layer number element can be C1, then the terminal may search for C1 in the components on the search panel.

The Nets connection type refers to a NET type. A target element of the NET type is generally configured to test and measure a signal, or rework a flying lead. The NET type includes network information of the target element, etc. When the element prediction type is the NET type, the terminal can search for a Nets connection element on the search panel according to the element identifier information. Specifically, the element identifier information of the Nets connection element may be EN_VDD50, then the terminal may search for EN_VDD50 in the NET type on the search panel.

The pin type refers to a PIN type; and a target element of the PIN type is generally configured to measure a resistor-capacitor device, or to quickly search for and measure a certain pin in a large-scale multi-pin chip. A target element of the PIN type includes pin information, etc. When the element prediction type is the PIN type, the terminal can disassemble the element identifier information on the search panel to obtain the disassembly result, and search for the pin element according to the disassembly result. Specifically, the element identifier information of the pin element may be U1.3, and the terminal may disassemble the element identifier information. For example, “U1.3” represents the third pin of the chip U1. Accordingly, the terminal can first use a dot to disassemble “U1.3”, then find the chip U1, and finally locate the third pin.

The copper foil type refers to a Shape type; and a target element of the Shape type is generally configured to debug a power supply, detect a flying lead, and check a time sequence, etc. The Shape type includes position and coordinate information of the copper foil. When the element prediction type is the Shape type, the terminal can search for at least one initial copper foil element on the search panel according to the element identifier information, and then determine the target copper foil element according to an area of each initial copper foil element. Specifically, the element identifier information of the copper foil element may be VDD50 (representing a power plane); the terminal may search for at least one VDD50 in the Shape type on the search panel; and the terminal may determine a VDD50 with the largest area as the target copper foil element according to the area of each VDD50.

The differential pair type refers to a Diff Pair type; and a target element of the Diff Pair type is generally configured to set differential line impedance matching and equal length of winding differential line, or to test a differential signal during the debugging. The Diff Pair type includes network information of the differential line, etc. When the element prediction type is the Diff Pair type, the terminal can search for a differential pair element on the search panel according to the element identifier information.

The footprint type refers to a footprint type. A target element of the footprint type is generally configured to check a footprint, a pad, etc. The footprint type includes Symbol information of an element, etc. When the element prediction type is the footprint type, the terminal can search for the footprint element on the search panel according to the element identifier information.

In the above embodiment, for each element prediction type, the terminal may search for the target element based on the element identifier information according to the characteristics of each element prediction type, so that the search efficiency can be effectively improved.

In an embodiment, the element attribute information includes element mirroring information. A target layer includes a top layer, a bottom layer or an inner layer. The step of determining the target layer of the target element in the PCB layout based on the element attribute information includes the following steps S202-S214.

Step S202: when the element prediction type is the symbol type, a symbol element is determined to locate at the top layer of the PCB layout when element mirroring information of the symbol element is a first mark, and the symbol element is determined to locate at the bottom layer of the PCB layout when the element mirroring information of the symbol element is a second mark.

The first mark and the second mark are marks configured to identify a specific layer in which the symbol element is located. The first mark and the second mark may be any predefined characters, letters, numbers, character codes or the like. For example, the first mark and the second mark in the embodiment consist of letters. Specifically, the first mark in the embodiment may be defined as nil and the second mark may be defined as t; when the element mirroring information of the symbol element is nil, it is indicated that the element mirroring information of the symbol element is the first mark, and the symbol element is at the top layer. If the element mirroring information of the symbol element is t, it is indicated that the element mirroring information of the symbol element is the second mark, and the symbol element is at the bottom layer.

Step S204: when the element prediction type is the character layer number type, a character layer number element is determined to locate at the top layer of the PCB layout when the element mirroring information of the character layer number element is the first mark, and the character layer number element is determined to be located at the bottom layer of the PCB layout when the element mirroring information of the character layer number element is the second mark.

As for the character layer number type, when the character layer number element is determined to be located at the bottom layer or the top layer of the PCB layout, the element mirroring information is also determined as the first mark or the second mark according to the element mirroring information of the character layer number element. When the element mirroring information of the character layer number element is the first mark, the character layer number element is determined to be located at the top layer; and when the element mirroring information of the character layer number element is the second mark, the character layer number element is determined to be located at the bottom layer.

Step S206: when the element prediction type is the Nets connection type, it is directly determined that the target layer of the Nets connection element is one of the top layer, the bottom layer, or the inner layer.

As for the Nets connection element, when determining whether a layer is the top layer, the bottom layer or the inner layer, the terminal can directly determine the layer where the Nets connection element is located without acquiring the element mirroring information of the Nets connection element.

Step S208: when the element prediction type is the pin type, the pin element is determined to be located at the top layer of the PCB layout when the element mirroring information of the pin element is the first mark; and the pin element is determined to be located at the bottom layer of the PCB layout when the element mirroring information of the pin element is the second mark.

As for the pin type, when the pin element is determined to be located at the bottom layer or the top layer of the PCB layout, the element mirroring information is also determined as the first mark or the second mark according to the element mirroring information of the pin element; the pin element is determined to locate in the top layer when the element mirroring information of the pin element is the first mark, and the pin element is determined to be located at the bottom layer when the element mirroring information of the pin element is the second mark.

Step S210: when the element prediction type is the copper foil type, the target copper foil element is determined to be located at the top layer of the PCB layout when the element mirroring information of the target copper foil element is the first mark, and the target copper foil element is determined to be located at the bottom layer of the PCB layout when the element mirroring information of the target copper foil element is the second mark.

As for the copper foil type, when the target copper foil element is determined to be in the bottom layer or the top layer of the PCB layout, the element mirroring information is also determined as the first mark or the second mark according to the element mirroring information of the target copper foil element; the target copper foil element is determined to be located at the top layer when the element mirroring information of the target copper foil element is the first mark; and the target copper foil element is determined to be located at the bottom layer when the element mirroring information of the target copper foil element is the second mark.

Step S212: when the element prediction type is the differential pair type, the target layer of the differential pair element is directly determined as any one of the top layer, the bottom layer, or the inner layer.

As for the Nets connection element, when determining whether a layer is the top layer, the bottom layer or the inner layer, the terminal can directly determine the layer where the Nets connection element is located without acquiring the element mirroring information of the differential pair element.

Step S214: when the element prediction type is the footprint type, the footprint element is determined to be located at the top layer of the PCB layout when the element mirroring information of the footprint element is the first mark; and the footprint element is determined to be located at the bottom layer of the PCB layout when the element mirroring information of the footprint element is the second mark.

As for the footprint type, when the footprint element is determined to be located at the bottom layer or the top layer of the PCB layout, the element mirroring information is also determined as the first mark or the second mark according to the element mirroring information of the footprint element; the footprint element is determined to be located at the top layer when the element mirroring information of the footprint element is the first mark; and the footprint element is determined to be located at the bottom layer when the element mirroring information of the footprint element is the second mark.

In the above embodiment, the terminal respectively determines the specific layer of each type of target element, so that the target element can be opened at the target layer of each target element to assist the design process, the debugging process of the user, etc., thereby improving the work efficiency of the user.

In an embodiment, the element attribute information includes element position information. The step of opening the target element at the target layer and highlighting the opened target element includes:

the target element is opened at the target layer based on the element position information, and is highlighted at the target layer after the opened target element is scaled and highlighted.

The element position information refers to the information configured to position the target element. Specifically, the element position information may refer to a coordinate and other information of the target element; and the scaling process may refer to reduction and amplification of the target element. When the terminal scales the target element, the target element can be automatically amplified in combination with an actual situation of the target element to obtain the scaled target element. Furthermore, after scaling the target element, the terminal can also highlight the target element differently, so that the user can quickly identify the opened target element.

In the above embodiment, the terminal may scale and highlight the opened target element, in order to play an assistant role and improve the work efficiency overall.

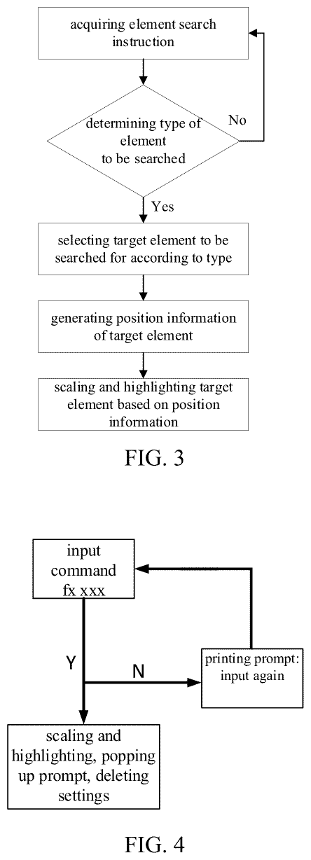

In an embodiment, as shown in FIG. 3, a flow chart showing an element search method according to an embodiment is provided.

The embodiment relates to a general process of searching for a target element as follows.

After receiving an element search command, the terminal can activate the search process according to the element search command. After the search process is activated, the terminal can determine the element type needing to be found according to relevant information carried in the element search command.

If the element type cannot be determined, a new element search command can be obtained. If the element type can be determined, the target element can be searched for according to the element type. The purpose of search varies. For example, a certain device needs to be found for the design, a certain network needs to be found for the debugging, or a certain copper foil is needed to measure a voltage, so that it is necessary to determine whether the type for search is the device, the network (Net), the differential pair or Design Rule Check (DRC) and so on.

When the target element is found, the position information of the target element can be generated; and the terminal can automatically select the target element according to the position information of the target element, and display the target element after scaling and highlighting the target element.

In an embodiment, as shown in FIG. 4, a flow chart showing an element search method according to an embodiment is provided.

The user only needs to input an element search command, and a format of the element search command may be fx xxx. Where xxx is the target element that the user needs to find. When the terminal determines that the element search command does not meet the requirement, a prompt message may pop up to prompt the user to input again. When the terminal determines that the element search command meets the requirement, the terminal may automatically find the target element, and scale and highlight the target element, and then display the target element to the user. After the user finishes using the target element, the terminal may clear the previous settings to avoid interfering with subsequent applications.

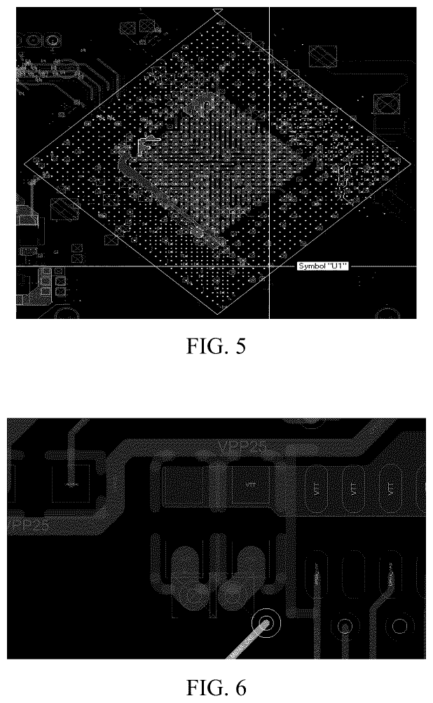

Specifically, as shown in FIG. 5, the target element searched for by the terminal is a device element, and the element search command may be fx U1. The terminal performs search processing on U1, and switches to the top layer where U1 is located to open U1, and then amplifies and highlights U1. As shown in FIG. 6, the target element searched for by the terminal is a pin element C1.1. The element search command may be fx C1.1. The terminal performs the search processing on C1.1, switches to the bottom layer where C1.1 is located to open C1.1, and then amplifies and highlights C1.1.

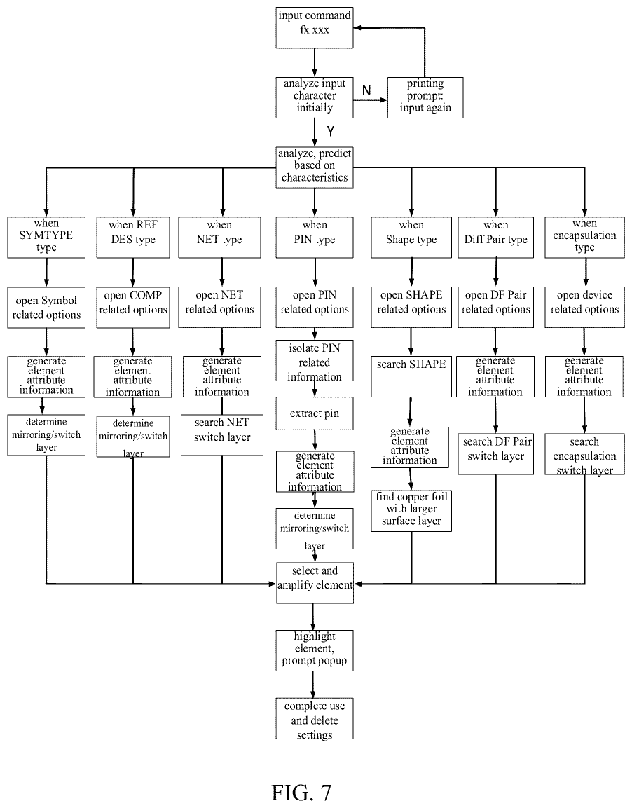

In an embodiment, as shown in FIG. 7, a flow chart showing an element search method according to an embodiment is provided.

Firstly, an executive body in the embodiment is the terminal; and the following steps are specific steps for the terminal to search for any element in the PCB layout.

Firstly, the user can input an element search command “fx xxx” through a command bar of the terminal itself; “fx” is a user-defined trigger source and an actual operation instruction, and is configured to deal with all branch determinations and operation processing of the system; “xxx” is an actual operation object, and “xxx” may carry information related to the operation object (that is, the target element to be searched for). Specifically, “xxx” may be any element such as a network, a pin, a copper foil, etc.

After receiving the element search command, the terminal may analyze the element search command, such as analyzing the element identifier information of the operation object. If the element search command meets the requirement, the next step is performed; otherwise, a printing prompt may pop up and indicate that: input again as required.

Specifically, as for the steps of popping up the print prompt, the prompt codes inside the terminal may be:

(if comp==nil then
println (“-----Please input what you want to find-----”)
println (“-----symbol: fx u1; Pin: fx u2.2, Net: fx txd, Shapes: fx
vdd33-----”)
else.

The meaning of the above codes can be understood as “please input the element search instruction you want, such as symbol: fx u1; Pin: fx u2.2; Net: fx txd; Shapes: fx vdd33, etc.”.

Further, if the inputted element search command is correct, the terminal may determine the type of the element identifier information of the operation object to determine the element prediction type matching the operation object. For example, if “fx u2.2” is inputted, the terminal can determine that the element prediction type is the pin type according to u2, and then a corresponding pin needs to be found.

As for different element prediction types, the specific steps are as follows.

If the SYMTYPE type is determined, the SYMTYPE type indicates a symbol (symbols of all PCB boards, not necessarily serial number) device; the symbol device may include all electrical devices and mechanical structures. When the element prediction type is the symbol type, the terminal can directly open the symbol device in the search panel according to element identifier information and search for the symbol element. Specifically, the element identifier information of the symbol element may be FIXOPT; the terminal may search for FIXOPT in the SYMTYPE type on the search panel and acquire the element attribute information of FIXOPT. The element attribute information may include key information such as a position coordinate, a layer and a name of FIXOPT, etc., and is temporarily stored in a database for subsequent operations. Generally, the symbol element may only exist on a surface layer, that is, the top or bottom layer, and the specific layer where the symbol element is located may be found by means of the following two manners. In the first manner, i.e., a direct manner, the layer where the symbol element is located is directly found. In the second manner, i.e., an indirect manner, a mirroring attribute of the symbol element is determined. If the mirroring attribute of the symbol element is nil, it means that the symbol is not mirrored, and accordingly the symbol element is at the top layer; conversely, if the mirroring attribute of the symbol is t, it means that the symbol is mirrored, and accordingly the symbol element is at the bottom layer.

In the case of the REFDES type, the REFDES type may indicate an element number character layer number and is generally configured to debug a device having electrical characteristics and check basic information of a device, etc. When the element prediction type is the character layer number type, the terminal can open components (components with sequence numbers in the PCB) on the search panel, and search for a character layer number element according to the element identifier information and acquire the element attribute information of the character layer number element. The element attribute information may include key information such as a position coordinate, a layer and a name of the character layer number element, which is temporarily stored in the database for subsequent operations. Specifically, the element identifier information of the character layer number element may be C1, and the terminal may find C1 in Components on the search panel. Accordingly, the element is opened according to the specific layer of the element, and the specific layer can be determined by means of the mirroring attribute information of the character layer number element.

In the case of the NET type, the target element of the NET type is generally configured to test and measure a signal, or rework a flying lead, etc. The NET type includes Nets connection information among various components, etc. When the element prediction type is the NET type, the terminal can search for the Nets connection element on the search panel according to the element identifier information and acquire the element attribute information of the Nets connection element. The element attribute information of the Nets connection element may include key information such as a position coordinate, a layer and a name of the Nets connection element, and is temporarily stored in the database for subsequent operations. Specifically, the element identifier information of the Nets connection element may be EN_VDD50, and then the terminal may search for EN_VDD50 in NET type on the search panel. Consequently, since the NET may exist at various layers and is not limited to the surface layer or the bottom layer, but may also be at the inner layer, the position of the network (Net) needs to be searched, to find the Net at the surface layer, bottom layer, or inner layer, and then subsequent operations are performed.

In the case of the PIN type, the target element of the PIN type is generally configured to measure a resistor or capacitor device, or to quickly search for and measure a certain pin in a large-scale multi-pin chip. A target element of the PIN type includes pin information, etc. When the element prediction type is the PIN type, the terminal can disassemble the element identifier information on the search panel to obtain the disassembly result, search for the pin element according to the disassembly result, and acquire the element attribute information of the pin element. The element attribute information of the pin element may include key information such as a position coordinate, a layer and a name of the pin element, etc., and is temporarily stored in the database for subsequent operations. Specifically, the element identifier information of the pin element may be U1.3, and the terminal may disassemble the element identifier information; for example, “U1.3” represents the third pin of the chip U1. Accordingly, the terminal can first use a comma to disassemble “U1.3”, and then find the chip U1, and finally locate the third pin.

Specifically, as for the search process of the PIN type element, the program codes inside the terminal may be:

```
  (when pinfind=axlSelectByName (“PIN”comp)
  println (pinfind)
  axlSetFindFilter(?enabled list(“noall” “PINS” “SYMBOLS”
“COMPONENTS”)?onButtons list(“noall” “PINS” “SYMBOLS” “COMPONENTS”))
  TempSymbol = car( parseString( comp “.”));
  TempComponent=axlGetSelSet(axlSingleSelectName(“COMPONENT”
strcat(TempSymbol))).
```

The above codes can be understood as the process of operation on the pin element. Specifically, when a target element of the PIN type is searched for on the Find panel, the element identifier information can be disassembled, and then the pin element is searched for according to the disassembly result. The wording “?enabled list” in the codes indicates whether to open options related to “Components” and “Pins”; and the wording “?onButtons” indicates whether to display options related to “Components” and “Pins”.

In the case of the Shape type, a target element of the Shape type is generally configured to debug the power supply, detect the flying lead, check the time sequence, or the like. The Shape type includes position and coordinate information of the copper foil. When the element prediction type is the Shape type, the terminal can find at least one initial copper foil element on the search panel according to the element identifier information, and then determine the target copper foil element according to the area of each initial copper foil element. Specifically, the element identifier information of the copper foil element may be VDD50 (representing a power plane), and then the terminal may find at least one copper foil element VDD50 in the Shape type on the search panel; the terminal may determine a copper foil element VDD50 with the largest area as the final copper foil element according to the area of each copper foil element VDD50, and acquire the element attribute information of the copper foil element. The element attribute information of the copper foil element may include key information such as a position coordinate, a layer and a name of the copper foil element, and is stored in a temporary database for subsequent operations. The specific layer can also be determined by means of the mirroring attribute information of the copper foil element.

In the case of the Diff Pair type, a target element of the Diff Pair type is generally configured to set differential line impedance matching and equal length of winding differential line, or to test a differential signal during the debugging. The Diff Pair type includes network information of the differential line, etc. When the element prediction type is the Diff Pair type, the terminal can search for a differential pair element on the search panel according to the element identifier information, and acquire the element attribution information of the differential pair element. The element attribute information of differential pair element may include key information such as a position coordinate, a layer and a name of the differential pair element, etc., and is stored temporarily in the database for subsequent operations. Consequently, the Diff Pair element is opened according to the specific layer where the Diff Pair element is located. Since most of the differential line tests and actual differential lines exist on the surface layer, the system may give priority to opening the differential line on the surface layer by default. Only when the differential line does not exist on the surface layer, differential line on the inner layer is opened.

In the case of the footprint type, i.e., the footprint type, a target element of the footprint type is generally configured to check a footprint, a bonding pad, etc. The footprint type includes symbol information of the element, etc. When the element prediction type is the footprint type, the terminal can search for the footprint element on the search panel according to the element identifier information, and acquire the element attribute information of the footprint element. The element attribute information of the footprint element may include key information such as a position coordinate, a layer and a name of the footprint element, and is temporarily stored in the database for subsequent operations. Consequently, the footprint element is opened according to the specific layer where the footprint element is located. The footprint element generally only exists on the surface layer, i.e., on the top layer or the bottom layer.

In addition to the above-mentioned element types, the element search method involved in the embodiments of the present disclosure may also be applied to the check and search for information and other processes, such as the Design Rule Check (DRC), the searching of various information such as a frame, etc. The branch prediction is only performed according to characteristics of different elements and actual requirements, so that any required element can be found. Accordingly, the system has strong operability and extensive expansibility, and can be quickly applied to applications of other elements.

When the target element is opened at the target layer, the terminal can select the target element and then scale the target element to an appropriate proportion, which is convenient for finding and subsequent processing. The scaled element can generally be quickly identified. However, as for the existing high-density board (for example, the non-polar resistor-capacitor includes a chip with thousands of pins), it is difficult to see information of a specific device and pin at a glance. Therefore, the terminal can highlight the target elements differently; meanwhile, after the target elements are highlighted, a shortcut operation manner for removing the highlight may pop up, which is convenient to turn off the highlight in time after use and avoid affecting the subsequent use.

Finally, after the use of the found element in the design and debugging is finished, the relevant settings for the target element can be deleted according to the actual situation, to avoid interference with subsequent applications.

The above steps are the primary steps in searching for any element quickly with one click. In view of the above, the simplicity of operation is based on complex analysis, determination and prediction, thereby implementing the quick and convenient search.

It should be appreciated that although the steps in the flow charts of the embodiments described above are shown sequentially as indicated by the arrows, these steps are not definitely performed sequentially in the order indicated by the arrows. Unless specifically stated herein, the execution of these steps is not strictly limited in order, and these steps may be performed in other orders. Further, at least some steps in the flow charts as described in the embodiments may include a plurality of steps or stages that may not definitely be performed at the same time, but may be performed at different time; and the steps or stages may not definitely be performed sequentially, but may be performed in turns or alternately with other steps or at least some of other steps or stages.

Based on the same inventive concept, in an embodiment of the present disclosure, an element search apparatus for implementing the above-mentioned element search method is provided. The technical solution for addressing the technical problem provided by the apparatus is similar to the technical solution of the method described above, so that as for the specific limitations in one or more embodiments of the element search apparatus provided below, reference can be made to the limitations of the above-mentioned element search method, which is not repeated herein.

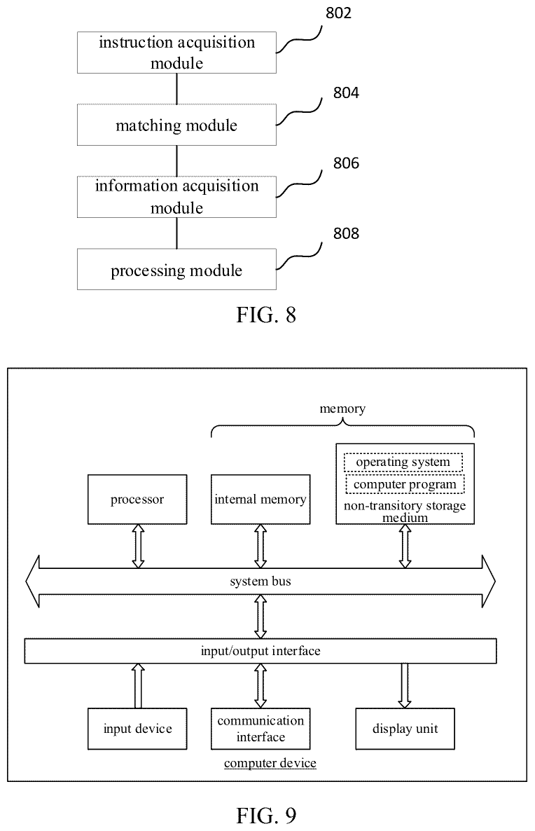

In an embodiment, as shown in FIG. 8, an element search apparatus is provided, which includes: an instruction acquisition module, a matching module, an information acquisition module, and a processing module.

The instruction acquisition module 802 is configured to acquire an element search instruction carrying an element identifier information of a target element.

The matching module 804 is configured to determine an element prediction type matching the target element based on the element identifier information.

The information acquisition module 806 is configured to search for the target element on a search panel according to the element prediction type, to acquire element attribute information of the target element.

The processing module 808 is configured to determine a target layer of the target element in the PCB layout based on the element attribute information, open the target element at the target layer, and highlight the opened target element.

In an embodiment, the apparatus further includes a trigger module.

The trigger module is configured to determine whether trigger information carried in the element search instruction matches predefined trigger information, determine whether the element identifier information meets a search requirement when the trigger information matches the predefined trigger information, and perform the step of determining the element prediction type matching the target element based on the element identifier information when the element identifier information meets the search requirement.

In an embodiment, the matching module is further configured to directly determine the element prediction type matching the target element according to the element identifier information when the element identifier information excludes a preset symbol, and disassemble the element identifier information when the element identifier information includes a preset symbol, and determine the element prediction type matching the target element according to a disassembly result.

In an embodiment, the information acquisition module is further configured to: search for a symbol element on the search panel according to the element identifier information when the element prediction type is a symbol type; search for a character layer number element on the search panel according to the element identifier information when the element prediction type is a character layer number type; search for a Nets connection element on the search panel according to the element identifier information when the element prediction type is a Nets connection type; disassemble the element identifier information on the search panel to obtain the disassembly result when the element prediction type is a pin type, and search for a pin element according to the disassembly result; search for at least one initial copper foil element on the search panel according to the element identifier information when the element prediction type is a copper foil type, and determine a target copper foil element according to an area of each initial copper foil element; search for a differential pair element on the search panel according to the element identifier information when the element prediction type is a differential pair type; search for a footprint element on the search panel according to the element identifier information when the element prediction type is a footprint type.

In an embodiment, the element attribute information includes element mirroring information; the target layer includes a top layer, a bottom layer or an inner layer; the processing module is further configured to: when the element prediction type is the symbol type, determine that a symbol element is located at the top layer of the PCB layout when element mirroring information of the symbol element is a first mark, and determine that the symbol element is located at the bottom layer of the PCB layout when the element mirroring information of the symbol element is a second mark; when the element prediction type is the character layer number type, determine that a character layer number element is located at the top layer of the PCB layout when the element mirroring information of the character layer number element is the first mark, and determine that the character layer number element is located at the bottom layer of the PCB layout when the element mirroring information of the character layer number element is the second mark; directly determine the target layer of the Nets connection element as one of the top layer, the bottom layer, or the inner layer when the element prediction type is the Nets connection type; when the element prediction type is the pin type, determine that the pin element is located at the top layer of the PCB layout when the element mirroring information of the pin element is the first mark, and determine that the pin element is located at the bottom layer of the PCB layout when the element mirroring information of the pin element is the second mark; when the element prediction type is the copper foil type, determine that the target copper foil element is located at the top layer of the PCB layout when the element mirroring information of the target copper foil element is the first mark, and determine that the target copper foil element is located at the bottom layer of the PCB layout when the element mirroring information of the target copper foil element is the second mark; directly determine the target layer of the differential pair element as one of the top layer, the bottom layer, or the inner layer when the element prediction type is the differential pair type; when the element prediction type is the footprint type, determine that the footprint element is located at the top layer of the PCB layout when the element mirroring information of the footprint element is the first mark, and determine that the footprint element is located at the bottom layer of the PCB layout when the element mirroring information of the footprint element is the second mark.

In an embodiment, the processing module is further configured to open the target element at the target layer based on the element position information, scale and highlight the opened target element before highlighting the target element at the target layer.

Each module in the element search apparatus described above may be implemented in whole or in part by software, hardware, and combination thereof. The aforementioned modules may be embedded in hardware or independently of the processor in the computer device, or may be stored in memory of the computer device in the form of software, in order to facilitate the processor to call and perform operations corresponding to the above modules.

In an embodiment, a computer device is provided, which may be a terminal, and an internal structure diagram thereof is shown in FIG. 9. The computer device includes a processor, a memory, an input/output interface, a communication interface, a display unit and an input device. The connections among the processor, the memory and the input/output interface are implemented through a system bus; the communication interface, the display unit and the input device are connected to the system bus through the input/output interface. The processor of the computer device is configured to provide computing and control capabilities. The memory of the computer device includes a non-transitory storage medium and an internal memory. The non-transitory storage medium stores an operating system and computer programs. The memory provides an operation environment for the operating system and computer programs in non-transitory storage medium. The input/output interface of the computer device is configured to exchange information between the processor and an external device. The communication interface of the computer device is configured to perform the wired or wireless communication with an external terminal, and the wireless mode can be implemented through WIFI, mobile cellular network, near-field communication (NFC) or other technologies. The computer program is executed by the processor to implement an element search method. The display unit of the computer device is configured to form a visually visible picture, which can be a display screen, a projection device or a virtual reality imaging device. The display screen can be a liquid crystal display screen or an electronic ink display screen; and the input device of the computer device can be a touch layer covering the display screen, or keys, a trackball or a touch pad provided on the housing of the computer device, or an externally connected keyboard, a touch pad or a computer mouse, etc.

Those skilled in the art may appreciate that the structure shown in FIG. 9, which is merely a block diagram of a portion of the structure associated with the present disclosure, but does not constitute a limitation to the computer device to which the present disclosure applies. The specific computer device may include more or less components than shown in the drawings, or may combine certain components, or may have different component arrangements.

In an embodiment, a computer device is provided, which includes a processor and a memory storing a computer program, the processor, when executing the computer program, implements the steps of the element search method described above.

In an embodiment, a computer-readable storage medium is provided, on which a computer program is stored, the steps of implementing the above-mentioned element search method when the computer program is executed by a processor.

In an embodiment, a computer program product is provided, which includes a computer program, the above-mentioned element search method is implemented when the computer program is executed by a processor.

It should be noted that the user information (including but not limited to user device information, user personal information, etc.) and data (including but not limited to data for analysis, stored data, displayed data, etc.) in the present disclosure are all information and data authorized by users or fully authorized by all parties, and the collection, use and processing of the data need to comply with relevant laws, regulations and standards of relevant countries and regions.

Those of ordinary skill in the art can understand that all or part of the procedures in the method of the above embodiments can be implemented by instructing relevant hardware through a computer program, and the computer program can be stored in a non-transitory computer-readable storage medium, when the computer program is executed, the procedures in the above-mentioned method embodiments can be performed. Any reference to a memory, a database or other media used in the various embodiments provided in the present disclosure may include at least one of a non-transitory memory and a transitory memory. The non-transitory memory may include a Read-Only Memory (ROM), a magnetic tape, a floppy disk, a flash memory, an optical memory, a high-density embedded non-transitory memory, a resistive memory (ReRAM), a Magnetoresistive Random Access Memory (MRAM), a Ferroelectric Random Access Memory (FRAM), a Phase Change Memory (PCM), a graphene memory, etc. The transitory memory may include a Random Access Memory (RAM) or an external cache memory, and the like. As an illustration and not a limitation, the RAM may be in various forms, such as a Static Random Access Memory (SRAM) or a Dynamic Random Access Memory (DRAM). The database involved in the various embodiments provided in the present disclosure may include at least one of a relational database and a non-relational database. The non-relational database may include a block chain-based distributed database, etc., but is not limited thereto. The processor involved in the various embodiments provided in the present disclosure may be a general-purpose processor, a central processing unit, a graphics processor, a digital signal processor, a programmable logic device, a data processing logic device based on quantum computation, etc., but is not limited thereto.

The technical limitations in the above embodiments can be combined arbitrarily. In order to make the description concise, all possible combinations of the technical limitations in the above embodiments are not described. However, as long as there is no contradiction in the combination of these technical limitations, theses combinations considered to fall within the scope of the present disclosure.

The above-mentioned embodiments merely some exemplary embodiments of the present disclosure, and the descriptions thereof are relatively specific and detailed, but should not be construed as a limitation on the scope of the present disclosure. It should be pointed out that those skilled in the art can make several modifications and improvements without departing from the concept of the present disclosure, which all belong to the protection scope of the present disclosure. Therefore, the scope of protection of the present disclosure should be subject to the appended claims.

What is claimed is:

1. An element search method, comprising:
acquiring an element search instruction carrying an element identifier information of a target element;
determining an element prediction type matching the target element based on the element identifier information;
searching for the target element on a search panel according to the element prediction type to acquire element attribute information of the target element;
determining a target layer of the target element in a Printed Circuit Board (PCB) layout based on the element attribute information, opening the target element at the target layer, and highlighting the opened target element.

2. The method according to claim 1, wherein the element search instruction further carries trigger information;
the method further comprises:
before determining the element prediction type matching the target element based on the element identifier information,
determining whether the trigger information matches predefined trigger information;
determining whether the element identifier information meets a search requirement when the trigger information matches the predefined trigger information;
when the element identifier information meets the search requirement, performing the step of determining the element prediction type matching the target element based on the element identifier information.

3. The method according to claim 1, wherein the determining the element prediction type matching the target element based on the element identifier information comprises:
directly determining the element prediction type matching the target element according to the element identifier information when the element identifier information excludes a preset symbol;
disassembling the element identifier information when the element identifier information includes the preset symbol, and determining the element prediction type matching the target element according to a disassembly result.

4. The method according to claim 1, wherein the searching for the target element on the search panel according to the element prediction type comprises:
searching for a symbol element on the search panel according to the element identifier information when the element prediction type is a symbol type;
searching for a character layer number element on the search panel according to the element identifier information when the element prediction type is a character layer number type;
searching for a Nets connection element on the search panel according to the element identifier information when the element prediction type is a Nets connection type;
disassembling the element identifier information on the search panel to obtain a disassembly result when the element prediction type is a pin type, and searching for a pin element according to the disassembly result;
searching for at least one initial copper foil element on the search panel according to the element identifier information when the element prediction type is a copper foil type, and determining a target copper foil element according to an area of each initial copper foil element;
searching for a differential pair element on the search panel according to the element identifier information when the element prediction type is a differential pair type;
searching for a footprint element on the search panel according to the element identifier information when the element prediction type is a footprint type.

5. The method according to claim 4, wherein the element attribute information comprises element mirroring information; the target layer comprises a top layer, a bottom layer or an inner layer; and the determining the target layer of the target element in the PCB layout based on the element attribute information comprises:
when the element prediction type is the symbol type, determining that the symbol element is located at the top layer of the PCB layout when element mirroring information of the symbol element is a first mark, and determining that the symbol element is located at the bottom layer of the PCB layout when the element mirroring information of the symbol element is a second mark;
when the element prediction type is the character layer number type, determining that the character layer number element is located at the top layer of the PCB layout when element mirroring information of the character layer number element is the first mark, and determining that the character layer number element is located at the bottom layer of the PCB layout when the element mirroring information of the character layer number element is the second mark;
directly determining the target layer of the Nets connection element as one of the top layer, the bottom layer, or the inner layer when the element prediction type is the Nets connection type;
when the element prediction type is the pin type, determining that the pin element is located at the top layer of the PCB layout when element mirroring information of the pin element is the first mark, and determining that the pin element is located at the bottom layer of the PCB layout when the element mirroring information of the pin element is the second mark;
when the element prediction type is the copper foil type, determining that the target copper foil element is located at the top layer of the PCB layout when element mirroring information of the target copper foil element is the first mark, and determining that the target copper foil element is located at the bottom layer of the PCB layout when the element mirroring information of the target copper foil element is the second mark;
directly determining the target layer of the differential pair element as one of the top layer, the bottom layer, or the inner layer when the element prediction type is the differential pair type;
when the element prediction type is the footprint type, determining that the footprint element is located at the top layer of the PCB layout when element mirroring information of the footprint element is the first mark, and determining that the footprint element is located at the bottom layer of the PCB layout when the element mirroring information of the footprint element is the second mark.

6. The method according to claim 1, wherein the element attribute information comprises element position information;
the opening the target element at the target layer and highlighting the opened target element comprises:
opening the target element at the target layer based on the element position information;
scaling and highlighting the opened target element before highlighting the target element at the target layer.

7. An element search apparatus, comprising:
an instruction acquisition module, configured to acquire an element search instruction carrying an element identifier information of a target element;
a matching module, configured to determine an element prediction type matching the target element based on the element identifier information;
an information acquisition module, configured to search for the target element on a search panel according to the element prediction type, to acquire element attribute information of the target element;
a processing module, configured to determine a target layer of the target element in a Printed Circuit Board (PCB) layout based on the element attribute information, open the target element at the target layer, and highlight the opened target element.

8. A computer device, comprising a processor and a memory for storing a computer program, wherein the processor, when executing the computer program, implements the method of claim 1.

9. A computer-readable storage medium, on which a computer program is stored, wherein the method of claim 1 is implemented when the computer program is executed by a processor.

10. A computer program product, comprising a computer program, wherein the method of claim 1 is implemented when the computer program is executed by a processor.
